(19) United States
(12) Patent Application Publication
(10) Pub. No.: US 2019/0283008 A1
(43) Pub. Date: Sep. 19, 2019

(54) BIMETALLIC CATALYTIC COMPOUNDS AND COMPOSITIONS COMPRISING PERMETHYLPENTALENE LIGANDS

(71) Applicant: SCG CHEMICALS CO., LTD., Bangsue Bangkok (TH)

(72) Inventors: Dermot O'HARE, Oxford (GB); Jean-Charles BUFFET, Oxford (GB); Zoe TURNER, Oxford (GB); Samantha BINDING, Oxford (GB); Duncan FRASER, Oxford (GB)

(21) Appl. No.: 16/317,657

(22) PCT Filed: Jul. 6, 2017
(86) PCT No.: PCT/GB2017/051994

§ 371 Date: Jan. 14, 2019

(30) Foreign Application Priority Data
Jul. 15, 2016 (GB) 1612334.1

(51) Int. Cl. B01J 31/22; C08F 4/622; C08F 4/6592; C08F 210/16; C08F 4/6392

(52) U.S. Cl. CPC B01J 31/2295; B01J 2531/0208; C08F 4/65922; C08F 210/16; C08F 4/63922; B01J 2231/122; C08F 2410/03; B01J 2531/0225; B01J 2531/842; B01J 2531/845; B01J 2531/847; B01J 2531/827; B01J 2531/822; B01J 2531/48; B01J 2531/46; C08F 4/6228

(57) ABSTRACT

Bimetallic catalytic compounds and compositions comprising permethylpentalene ligands, as well as their methods of preparation, are described. The catalytic compounds and compositions are promising catalysts in olefin (e.g. ethylene) polymerisation reactions.

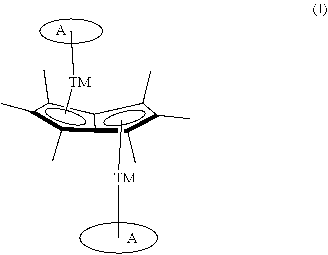

### INTRODUCTION

The present invention relates to catalytic compounds and compositions, as well as to processes for preparing them and their uses in catalytic applications. More particularly, the present invention relates to bimetallic catalytic compounds and compositions comprising permethylpentalene ligands, as well as their uses in olefin polymerisation reactions.

### BACKGROUND OF THE INVENTION

The interaction between metal centres in bimetallic compounds has been the subject of intense research, given that many bimetallic compounds exhibit unusual electronic properties and novel reactivity.

Bimetallic complexes enable metal centres to be brought into close proximity. The bridging ligand may support electronic coupling between the two metal centres and so provide a mechanism by which the two metals may interact to engage in synergistic reactivity such as catalytic chemistry. Bimetallic complexes may be either homobimetallic or heterobimetallic. Heterobimetallic complexes allow the possibility of 2 metal centres with different reactivity.

Despite the advances made to-date, there remains a need for bimetallic catalysts having useful catalytic properties.

The present invention was devised with the foregoing in mind.

### SUMMARY OF THE INVENTION

According to a first aspect of the present invention there is provided a compound having a structure according to formula (I) defined herein.

According to a further aspect of the present invention, there is provided a composition comprising a compound of formula (I) defined herein and
i. a support material; and/or
ii. an activator.

According to a further aspect of the present invention, there is provided a process for the preparation of a compound of formula (I) as defined herein, said process comprising the step of:
a) reacting a compound according to formula (II) defined herein with a compound according to formula (III) defined herein.

According to a further aspect of the present invention, there is provided a compound obtainable, obtained or directly obtained by a process defined herein

According to a further aspect of the present invention, there is provided a use of a compound of formula (I) as defined herein or a composition as defined herein in the polymerisation of ethylene and optionally one or more (3-10C)alkene.

According to a further aspect of the present invention, there is provided a polymerisation process comprising the step of:
a) polymerising ethylene and optionally one or more (3-10C)alkene in the presence of a compound of formula (I) as defined herein or a composition as defined herein.

### DETAILED DESCRIPTION OF THE INVENTION

### Definitions

The term “(m-nC)” or “(m-nC) group” used alone or as a prefix, refers to any group having m to n carbon atoms.

The term “hydrogen” as used herein includes isotopes thereof, in particular deuterium.

The term “alkyl” as used herein includes reference to a straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tert-butyl), pentyl (including neopentyl), hexyl and the like. In particular, an alkyl may have 1, 2, 3 or 4 carbon atoms.

The term “alkenyl” as used herein include reference to straight or branched chain alkenyl moieties, typically having 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “(3-10C)alkene” as used herein includes reference to any alkene having 3-10 carbon atoms that is capable of being copolymerised with ethylene. Straight and branching aliphatic alkenes are included (e.g. 1-hexene or 1-octene), as are alkenes comprising an aromatic moiety (e.g. styrene).

The term “alkynyl” as used herein include reference to straight or branched chain alkynyl moieties, typically having 2, 3, 4, 5 or 6 carbon atoms. The term includes reference to alkynyl moieties containing 1, 2 or 3 carbon-carbon triple bonds (C≡C). This term includes reference to groups such as ethynyl, propynyl, butynyl, pentynyl and hexynyl.

The term “alkoxy” as used herein include reference to —O-alkyl, wherein alkyl is straight or branched chain and comprises 1, 2, 3, 4, 5 or 6 carbon atoms. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “aryl” as used herein includes reference to an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like.

The term “heteroaryl” as used herein includes reference to an aromatic heterocyclic ring system having 5, 6, 7, 8, 9 or 10 ring atoms, at least one of which is selected from nitrogen, oxygen and sulphur. The group may be a polycyclic ring system, having two or more rings, at least one of which is aromatic, but is more often monocyclic. This term includes reference to groups such as pyrimidinyl, furanyl, benzo[b]thiophenyl, thiophenyl, pyrrolyl, imidazolyl, pyrrolidinyl, pyridinyl, benzo[b]furanyl, pyrazinyl, purinyl, indolyl, benzimidazolyl, quinolinyl, phenothiazinyl, triazinyl, phthalazinyl, 2H-chromenyl, oxazolyl, isoxazolyl, thiazolyl, isoindolyl, indazolyl, purinyl, isoquinolinyl, quinazolinyl, pteridinyl and the like.

The term “aryl(m-nC)alkyl” means an aryl group covalently attached to a (m-nC)alkylene group. Examples of aryl-(m-nC)alkyl groups include benzyl, phenylethyl, and the like.

The term “partially unsaturated cycloalkyl” as used herein refers to a cycloalkyl ring system containing 1 or more C—C double bonds (i.e. C═C). Exemplary partially unsaturated cycloalkyl groups used herein are cyclooctadiene (COD), pentalene, and cyclopentadiene.

The term “halogen” or “halo” as used herein includes reference to F, Cl, Br or I. In a particular, halogen may be F or CI, of which CI is more common.

The term “substituted” as used herein in reference to a moiety means that one or more, especially up to 5, more especially 1, 2 or 3, of the hydrogen atoms in said moiety are replaced independently of each other by the corresponding number of the described substituents. The term “optionally substituted” as used herein means substituted or unsubstituted.

It will, of course, be understood that substituents are only at positions where they are chemically possible, the person skilled in the art being able to decide (either experimentally or theoretically) without inappropriate effort whether a particular substitution is possible. For example, amino or hydroxy groups with free hydrogen may be unstable if bound to carbon atoms with unsaturated (e.g. olefinic) bonds. Additionally, it will of course be understood that the substituents described herein may themselves be substituted by any substituent, subject to the aforementioned restriction to appropriate substitutions as recognised by the skilled person.

Compounds of the Invention

As described hereinbefore, the present invention provides a compound having a structure according to formula (I) shown below:

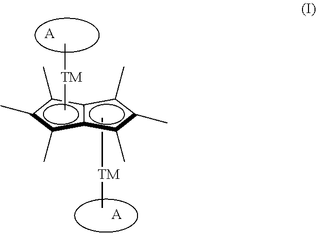

wherein
each TM is independently a transition metal; and
each ring A is independently a 5-8 membered aryl, heteroaryl or partially unsaturated cycloalkyl that is:
   i) optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃, and/or
   ii) fused to one or more 5- or 6-membered aryl, heteroaryl, or partially unsaturated cycloalkyl rings, either or all of which being optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃,
      wherein Rₓ and R_{y} are independently selected from H and (1-4C)alkyl.

The compounds of the invention are promising catalysts for olefin (notably ethylene) polymerisation reactions, as well as other catalytic reactions (e.g. hydrogenation, isomerisation, hydroboration, hydroacylation and hydroformylation).

Having regard to the structure of the compounds of formula (I), it will be understood that each TM is coordinated to ring A via 1 or more of the carbon atoms or heteroatoms constituting ring A (according to the principles of hapticity). Each M may be η¹, η², η³, η⁴, η⁵ or η⁸ coordinated to ring A. Typically, each M is η⁵ or η⁸ coordinated to ring A. For example, the scheme below illustrates a TM η⁴-bonded to a cyclooctadiene ligand, as well as a TM η⁵-bonded to a cyclopentadiene ligand and a TM η⁸-bonded to a permethylpentalene ligand.

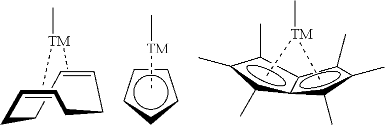

Still having regard to the structure of the compounds of formula (II), it will be understood that the two TM groups are positioned anti to one other (i.e. on opposite faces of the permethylpentalene ligand).

In an embodiment, each TM is independently selected from Rh, Ir, Ti, Ni, Co, Fe and Zr. Suitably, both TM groups are the same.

In another embodiment, each ring A is independently a 5-8 membered aryl, heteroaryl containing 1, 2 or 3 heteroatoms selected from N, O and S, or partially unsaturated cycloalkyl that is:
i. optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃, and/or
ii. fused to one or more 5- or 6-membered aryl, heteroaryl, or partially unsaturated cycloalkyl rings, either or all of which being optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃,
   wherein Rₓ and R_{y} are independently selected from H and (1-4C)alkyl.

In another embodiment, each ring A is independently a 5-8 membered aryl, heteroaryl containing 1 or 2 N heteroatoms, or partially unsaturated cycloalkyl that is:
i. optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃, and/or
ii. fused to one or more 5- or 6-membered aryl, heteroaryl, or partially unsaturated cycloalkyl rings, either or all of which being optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃,
   wherein Rₓ and R_{y} are independently selected from H and (1-4C)alkyl.

In another embodiment, each ring A is independently a phenyl, heteroaryl containing 1 or 2 N heteroatoms, or a 5- or 8-membered partially unsaturated cycloalkyl that is:
i. optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃, and/or
ii. fused to one or more 5- or 6-membered aryl, heteroaryl, or partially unsaturated cycloalkyl rings, either or all of which being optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃,
   wherein Rₓ and R_{y} are independently selected from H and (1-4C)alkyl.

In another embodiment, wherein each ring A is independently:
i. optionally substituted with one or more substituents selected from (1-3C)alkyl, (2-3C)alkenyl, (2-3C)alkynyl; (1-3C)alkoxy, halo and hydroxyl, and/or
ii. fused to one or more 5- or 6-membered aryl, heteroaryl, or partially unsaturated cycloalkyl rings, either or all of which being optionally substituted with one or more substituents selected from (1-3C)alkyl, (2-3C)alkenyl, (2-3C)alkynyl; (1-3C)alkoxy, halo and hydroxyl.

In another embodiment, each ring A is independently:
i. optionally substituted with one or more substituents selected from (1-3C)alkyl, (1-3C)alkoxy, halo and hydroxyl, and/or
ii. fused to one or more 5-membered partially unsaturated cycloalkyl ring that is optionally substituted with one or more substituents selected from (1-3C)alkyl, (1-3C)alkoxy, halo and hydroxyl.

In another embodiment, each ring A is independently selected from:

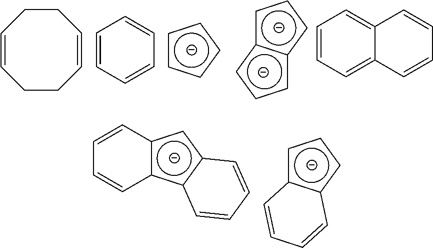

either of which may be optionally substituted with one or more of the ring A substituents recited hereinbefore.

It will be understood that when ring A is a bicycle, it may be coordinated to TM via either or both rings of the bicycle. Similarly, when ring A is a tricycle, it may be coordinated to TM via 1, 2 or 3 rings of the tricycle.

In another embodiment, each ring A is independently selected from:

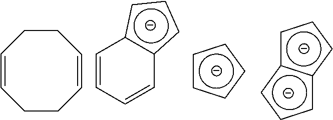

either of which may be optionally substituted with one or more substituents selected from (1-3C)alkyl.

In another embodiment, each ring A is independently selected from:

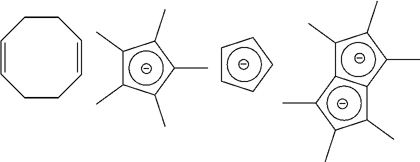

Suitably, both rings A are the same.

Exemplary, non-limiting, compounds of formula (I) are outlined below:

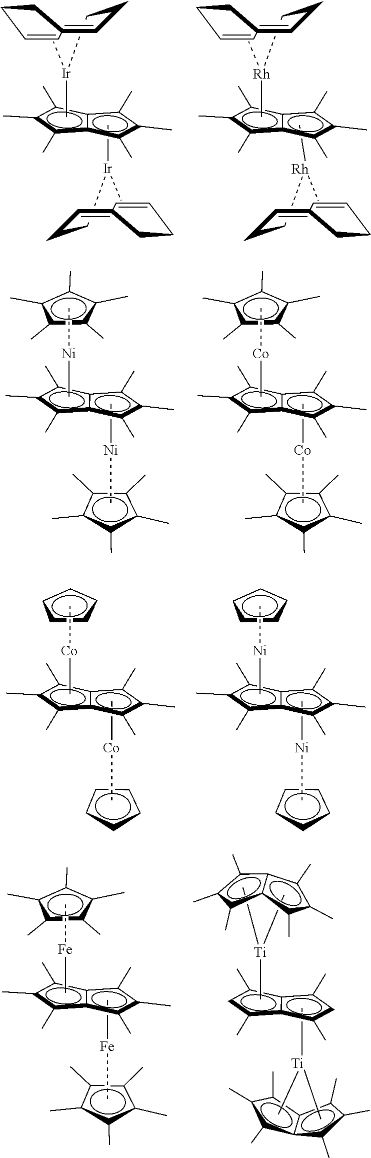

Compositions of the Invention

As described hereinbefore, the present invention also provides a composition comprising a compound of formula (I) defined herein and
i. a support material; and/or
ii. an activator.

The compositions of the invention may be advantageously used in heterogeneous catalytic applications. For example, the compositions of the invention are promising catalysts in olefin (notably ethylene) polymerisation reactions, as well as other catalytic reactions (e.g. hydrogenation, isomerisation, hydroboration, hydroacylation and hydroformylation).

In an embodiment, the composition comprises a compound of formula (I) defined herein, a support material, and optionally an activator. The compound of formula (I) may be associated with the support material by one or more ionic or covalent interactions. It will be understood that any minor structural modifications occurring to the compound of formula (I) arising from it being associated with the support material are within the scope of this invention.

In an embodiment, the support material is selected from silicas, layered-double hydroxides (LDH, e.g. AMO-LDH MgAI-CO₃, wherein “AMO” is an aqueous miscible organic solvent), and solid polymethylaluminoxane. Supports such as silica and AMO-LDH may be subjected to a heat treatment prior to use. An exemplary heat treatment involves heating the support to 400-600° C. (for silicas) or 100-150° C. (for AMO-LDHs) in a nitrogen atmosphere.

In another embodiment, the support material may be an activated support material. The support may be activated by the presence of a suitable activator being covalently bound to the support. Suitable activators include organo aluminium compounds (e.g. alkyl aluminium compounds), in particular methylaluminoxane. Examples of activated supports include methylaluminoxane activated silica and methylaluminoxane activated layered double hydroxide.

In another embodiment, the support material is an activated support material (e.g. MAO-activated silica), and the activator is selected from aluminoxanes (e.g. methylaluminoxane (MAO)), triisobutylaluminium (TIBA), diethylaluminiumchloride (DEAC) and triethylaluminium (TEA).

The terms “solid MAO” and “solid polymethylaluminoxane” are used synonymously herein to refer to a solid-phase material having the general formula -[(Me)AlO]ₙ—, wherein n is an integer from 4 to 50 (e.g. 10 to 50). Any suitable solid polymethylaluminoxane may be used.

There exist numerous substantial structural and behavioural differences between solid polymethylaluminoxane and other (non-solid) MAOs. Perhaps most notably, solid polymethylaluminoxane is distinguished from other MAOs as it is insoluble in hydrocarbon solvents and so acts as a heterogeneous support system. The solid polymethylaluminoxane useful in the compositions of the invention are insoluble in toluene and hexane.

In contrast to non-solid (hydrocarbon-soluble) MAOs, which are traditionally used as an activator species in slurry polymerisation or to modify the surface of a separate solid support material (e.g. SiO₂), the solid polymethylaluminoxanes useful as part of the present invention are themselves suitable for use as solid-phase support materials, without the need for an additional activator. Hence, compositions of the invention comprising solid polymethylaluminoxane are devoid of any other species that could be considered a solid support (e.g. inorganic material such as SiO₂, Al₂O₃ and ZrO₂). Moreover, given the dual function of the solid polymethylaluminoxane (as catalytic support and activator species), the compositions of the invention comprising solid MAO may contain no additional catalytic activator species.

In an embodiment, the solid polymethylaluminoxane is prepared by heating a solution containing MAO and a hydrocarbon solvent (e.g. toluene), so as to precipitate solid polymethylaluminoxane. The solution containing MAO and a hydrocarbon solvent may be prepared by reacting trimethyl aluminium and benzoic acid in a hydrocarbon solvent (e.g. toluene), and then heating the resulting mixture.

In an embodiment, the solid polymethylaluminoxane is prepared according to the following protocol:

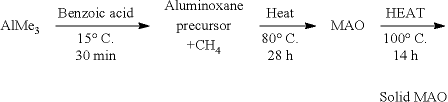

The properties of the solid polymethylaluminoxane can be adjusted by altering one or more of the processing variables used during its synthesis. For example, in the above-outlined protocol, the properties of the solid polymethylaluminoxane may be adjusted by varying the Al:O ratio, by fixing the amount of AlMe₃ and varying the amount of benzoic acid. Exemplary Al:O ratios are 1:1, 1.1:1, 1.2:1, 1.3:1, 1.4:1 and 1.6:1. Suitably the Al:O ratio is 1.2:1 or 1.3:1. Alternatively, the properties of the solid polymethylaluminoxane may be adjusted by fixing the amount of benzoic acid and varying the amount of AlMe₃.

In another embodiment, the solid polymethylaluminoxane is prepared according to the following protocol:

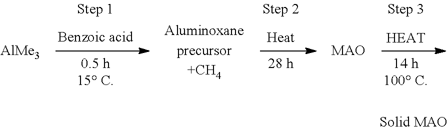

In the above protocol, steps 1 and 2 may be kept constant, with step 2 being varied. The temperature of step 2 may be 70-100° C. (e.g. 70° C., 80° C., 90° C. or 100° C.). The duration of step 2 may be from 12 to 28 hours (e.g. 12, 20 or 28 hours). The duration of step 2 may be from 5 minutes to 24 hours. Step 3 may be conducted in a solvent such as toluene.

In an embodiment, the aluminium content of the solid polymethylaluminoxane falls within the range of 36-41 wt %.

The solid polymethylaluminoxane useful as part of the present invention is characterised by extremely low solubility in toluene and n-hexane. In an embodiment, the solubility in n-hexane at 25° C. of the solid polymethylaluminoxane is 0-2 mol %. Suitably, the solubility in n-hexane at 25° C. of the solid polymethylaluminoxane is 0-1 mol %. More suitably, the solubility in n-hexane at 25° C. of the solid polymethylaluminoxane is 0-0.2 mol %. Alternatively or additionally, the solubility in toluene at 25° C. of the solid polymethylaluminoxane is 0-2 mol %. Suitably, the solubility in toluene at 25° C. of the solid polymethylaluminoxane is 0-1 mol %. More suitably, the solubility in toluene at 25° C. of the solid polymethylaluminoxane is 0-0.5 mol %. The solubility in solvents can be measured by the method described in JP—B(KOKOKU)-H07 42301.

In a particularly suitable embodiment, the solid polymethylaluminoxane is as described in US2013/0059990, WO2010/055652 or WO2013/146337, and is obtainable from Tosoh Finechem Corporation, Japan.

In an embodiment, the mole ratio of solid polymethylaluminoxane to the compound of formula (I) is 50:1 to 500:1. Suitably, the mole ratio of solid polymethylaluminoxane to the compound of formula (I) is 75:1 to 400:1. More suitably, the mole ratio of solid polymethylaluminoxane to the compound of formula (I) is 100:1 to 300:1.

In another embodiment, when the composition comprises a solid polymethylaluminoxane support material and no activator, the composition may additionally comprise a compound suitable for scavenging moisture and oxygen. Exemplary moisture and oxygen scavengers include alkylaluminium compounds, including triisobutylaluminium (TIBA) and methylaluminoxane (MAO).

### Preparation of Compounds and Compositions

As described hereinbefore, the present invention provides a process for the preparation of a compound of formula (I) as defined herein, said process comprising the step of
a) reacting a compound according to formula (II) shown below with a compound according to formula (III) shown below:

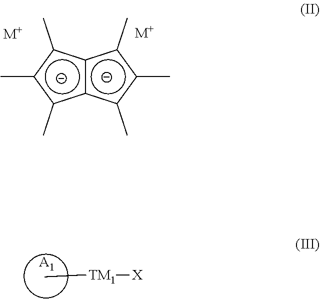

wherein
   M is an alkali metal;
   ring A, has a structure according to ring A as defined hereinbefore;
   TM₁ is as defined for TM hereinbefore; and
   X is a leaving group or a group of formula (IV):

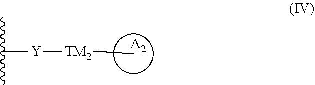

wherein
ring A₂ has a structure according to ring A as defined herein and may be the same as or different to A₁;
TM₂ is as defined herein for TM hereinbefore and is the same as or different to TM₁; and
Y is a linking moiety.

It will be appreciated that the compound of formula (II) may be coordinated to a suitable ligand. For example, the compound of formula (II) may be coordinated to tetramethylethylenediamine to give, for example, Pn*Li₂.tmedaₓ (x=0.1-0.3).

In an embodiment, when X is a leaving group, step a) comprises reacting one molar equivalent of a compound according to formula (II) with two molar equivalents of a compound according to formula (III), in which case both TM groups and both rings A in the resulting compound of formula (I) are identical. Alternatively, when X is a leaving group, step a) comprises reacting one molar equivalent of a compound according to formula (II) with one molar equivalent of a compound according to formula (III), and then reacting the resulting product with one equivalent of a different compound according to formula (III), in which case the TM groups and rings A in the resulting compound of formula (I) may be different.

In another embodiment, when X is a group of formula (IV), step a) comprises reacting one molar equivalent of a compound according to formula (II) with one molar equivalent of a compound according to formula (III). Depending on the identity of TM₁, TM₂, A₁ and A₂, the groups TM and rings A in the resulting compound of formula (I) may be the same or different.

In an embodiment, M is Li.

In another embodiment, the leaving group is selected from (1-10C)alkoxy, (1-10C)alkyl, halo (e.g. chloro) and aryloxy.

In another embodiment, Y is halo (e.g. chloro).

In another embodiment, the compound of formula (III) has a structure according to formula (IIIa) or (IIIb) shown below:

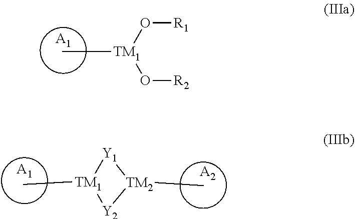

wherein
   rings A₁ and A₂ independently have structures according to ring A as defined herein;
   TM₁ and TM₂ are independently as defined herein for TM;
   R₁ and R₂ are independently (1-8C)alkyl, (2-8C)alkenyl, or R₁ and R₂ are linked such that when taken in combination with the oxygen atoms and TM₁ they collectively form a 6-membered ring that is optionally substituted with one or more substituents selected from (1-3C)alkyl; and
   Y₁ and Y₂ are halo.

In another embodiment, the compound of formula (III) has a structure according to formula (IIIa), wherein A₁ is a cyclopentadienyl, permethylcyclopentadienyl or permethylpentalenyl group. Suitably, TM₁ is Ni, Co, Ti or Fe. More suitably, R₁ and R₂ are linked, such that when taken in combination with the oxygen atoms and TM₁ to which they are attached, they collectively form a group:

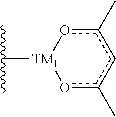

In another embodiment, the compound of formula (III) has a structure according to formula (IIIb), wherein A₁ and A₂ are both cyclooctadiene. Suitably, TM₁ and TM₂ are both Rh or Ir. More suitably, Y₁ and Y₂ are both chloro.

In another embodiment, step a) is conducted in a solvent selected from THF, C₆D₆, aromatics (e.g. toluene), aliphatic solvents (e.g. alkanes), chlorinated solvents, and ether.

Applications of Compounds and Compositions

As described hereinbefore, the present invention also provides a use of a compound of formula (I) as defined herein or a composition as defined herein in the polymerisation of ethylene and optionally one or more (3-10C)alkene.

The compounds and compositions of the invention may be used as catalysts in the preparation of a variety of polymers, including polyalkylenes (e.g. polyethylene) of varying molecular weight, and copolymers. Such polymers and copolymers may be prepared by homogeneous solution-phase polymerisation of a monomer-containing feed stream (e.g. using the compounds of the invention), or heterogeneous slurry-phase polymerisation of a monomer-containing feed stream (e.g. using the compositions of the invention).

In an embodiment, when the optional one or more (3-10C)alkene is not included, the compounds and compositions of the invention may be used to prepare polyethylene homopolymers.

In another embodiment, the optional one or more (3-10C)alkene is one or more (3-8C)alkene. Suitably, the quantity of the one or more (3-8C)alkene in the monomer feed stream is 0.05-10 mol %, relative to the quantity of ethylene monomers. More suitably, the one or more (3-8C)alkene is selected from 1-hexene, 1-octene and styrene. Hence, the compounds and compositions of the present invention are useful as catalysts in the preparation of copolymers such as poly(ethylene-co-hexene), poly(ethylene-co-octene) and poly(ethylene-co-styrene).

In another embodiment, in addition to ethylene and the optional one or more (3-10C)alkene, the polymerisation is also conducted in the presence of hydrogen. Hydrogen acts to control the molecular weight of the growing polymer or copolymer. When hydrogen is used alongside ethylene and the optional one or more (3-10C)alkene in the feed stream, the mole ratio of hydrogen to total alkenes in the feed stream is 0.001:1 to 0.5:1. Suitably, when hydrogen is used alongside ethylene and the optional one or more (3-10C)alkene, the mole ratio of hydrogen to total alkenes in the feed stream is 0.001:1 to 0.1:1. More suitably, when hydrogen is used alongside ethylene and the optional one or more (3-10C)alkene, the mole ratio of hydrogen to total alkenes in the feed stream is 0.001:1 to 0.05:1.

As described hereinbefore, the present invention also provides a polymerisation process comprising the step of:
a) polymerising ethylene and optionally one or more (3-10C)alkene in the presence of a compound of formula (I) as defined herein or a composition as defined herein.

The compounds and compositions of the invention may be used as catalysts in the preparation of a variety of polymers, including polyalkylenes (e.g. polyethylene) of varying molecular weight, and copolymers. Such polymers and copolymers may be prepared by homogeneous solution-phase polymerisation of a monomer-containing feed stream (e.g. using the compounds of the invention), or heterogeneous slurry-phase polymerisation of a monomer-containing feed stream (e.g. using the compositions of the invention).

In an embodiment, step a) is conducted at a temperature of 30-120° C. Suitably, step a) is conducted at a temperature of 40-80° C.

In another embodiment, step a) is conducted at a pressure of 1-10 bar.

In another embodiment, step a) is conducted in a suitable solvent (e.g. aromatics, including toluene, and/or alkanes, including hexanes or heptane).

In another embodiment, step a) may be conducted for between 1 minute and 5 hours. Suitably, step a) may be conducted for between 5 minutes and 2 hours.

In another embodiment, when the optional one or more (3-10C)alkene is not included, the process yields polyethylene homopolymer.

In another embodiment, the optional one or more (3-10C)alkene is one or more (3-8C)alkene. Suitably, the quantity of the one or more (3-8C)alkene in the monomer feed stream is 0.05-10 mol %, relative to the quantity of ethylene monomers. More suitably, the one or more (3-8C)alkene is selected from 1-hexene, 1-octene and styrene. Hence, the process may be used to prepare copolymers such as poly(ethylene-co-hexene), poly(ethylene-co-octene) and poly(ethylene-co-styrene).

In a particularly suitable embodiment, step a) comprises polymerising ethylene and styrene in the presence of a compound of formula (I) defined herein or composition as defined herein.

In another embodiment, in addition to ethylene and the optional one or more (3-10C)alkene, the polymerisation is also conducted in the presence of hydrogen. Hydrogen acts to control the molecular weight of the growing polymer or copolymer. When hydrogen is used alongside ethylene and the optional one or more (3-10C)alkene in the feed stream, the mole ratio of hydrogen to total alkenes in the feed stream is 0.001:1 to 0.5:1. Suitably, when hydrogen is used alongside ethylene and the optional one or more (3-10C)alkene, the mole ratio of hydrogen to total alkenes in the feed stream is 0.001:1 to 0.1:1. More suitably, when hydrogen is used alongside ethylene and the optional one or more (3-10C)alkene, the mole ratio of hydrogen to total alkenes in the feed stream is 0.001:1 to 0.05:1.

In another aspect, the present invention provides a use of a compound or composition defined herein as a catalyst in a reaction selected from hydrogenation, isomerisation, hydroboration, hydroacylation, hydroformylation and oligomerisation.

### EXAMPLES

One or more examples of the invention will now be described, for the purpose of illustration only, with reference to the accompanying figures, in which:

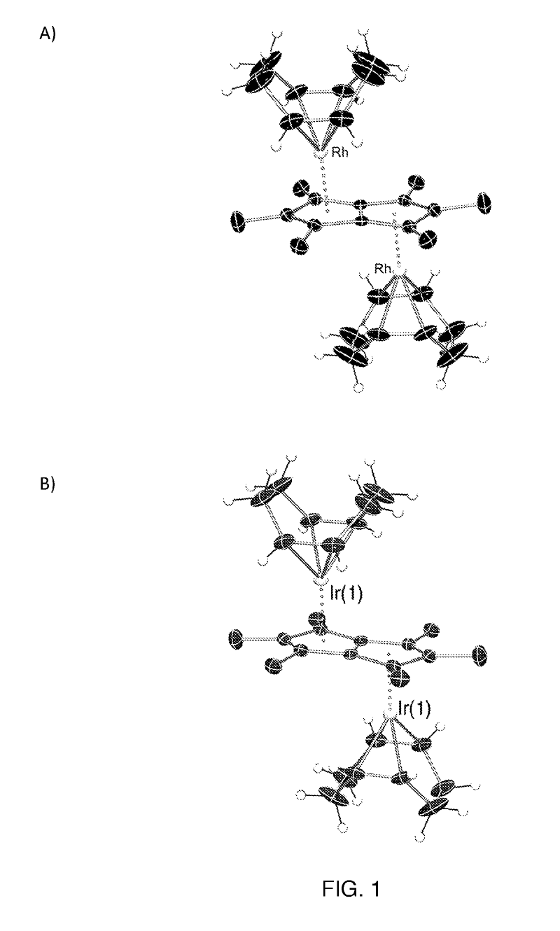

FIG. 1a shows the molecular structure of anti-Pn*(Rh{COD})₂, as deduced by X-ray crystallography. FIG. 1b shows the molecular structure of anti-Pn*(Ir{COD})₂, as deduced by X-ray crystallography.

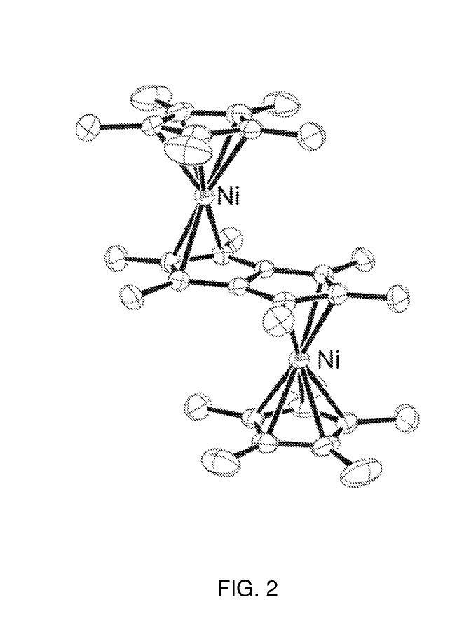

FIG. 2 shows the molecular structure of anti-Pn*(Ni{Cp*})₂, as deduced by X-ray crystallography.

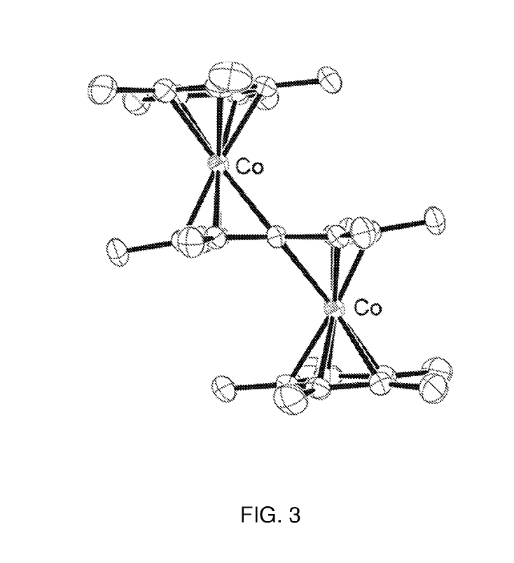

FIG. 3 shows the molecular structure of anti-Pn*(Co{Cp*})₂, as deduced by X-ray crystallography.

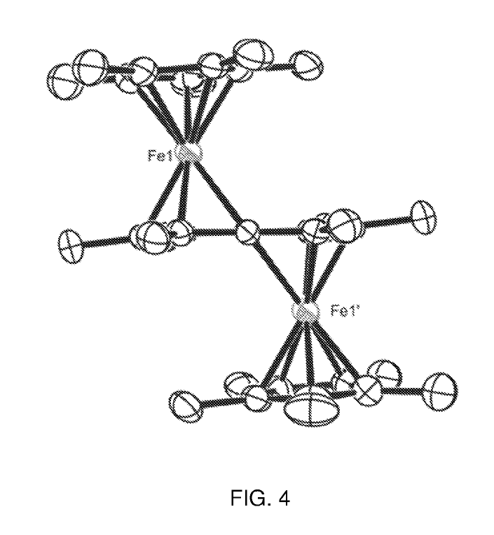

FIG. 4 shows the molecular structure of anti-Pn*(Fe{Cp*})₂, as deduced by X-ray crystallography.

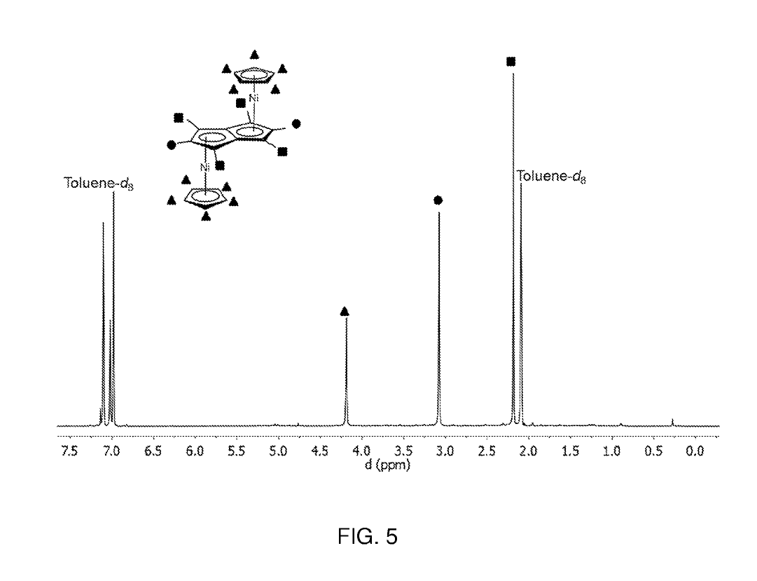

FIG. 5 shows ¹H NMR spectrum of anti-Pn*(Ni{Cp})₂.

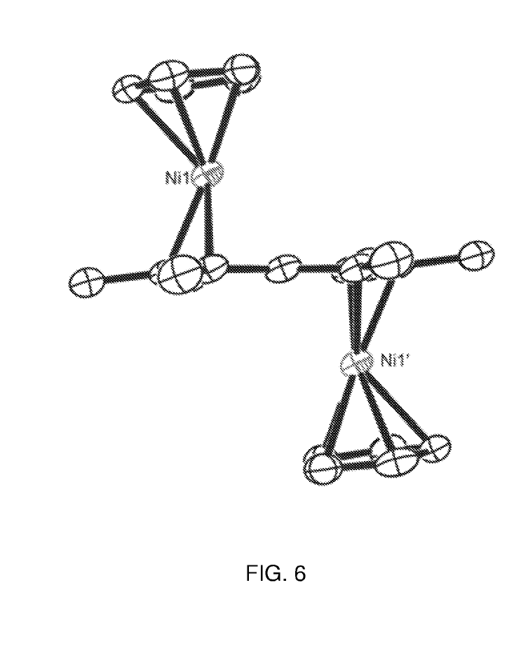

FIG. 6 shows the molecular structure of anti-Pn*(Ni{Cp})₂, as deduced by X-ray crystallography.

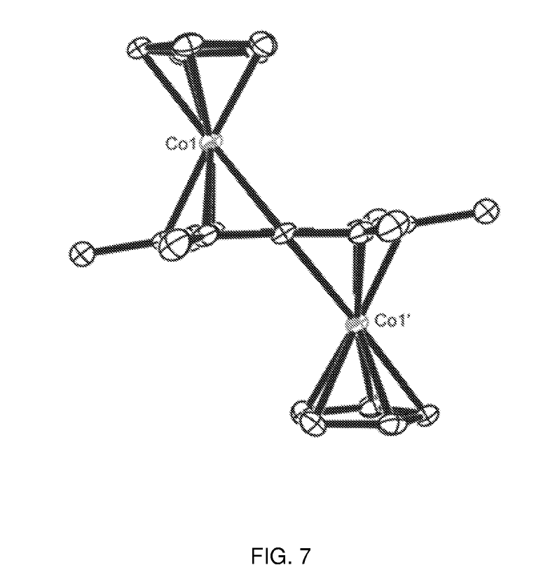

FIG. 7 shows the molecular structure of anti-Pn*(Co{Cp})₂, as deduced by X-ray crystallography.

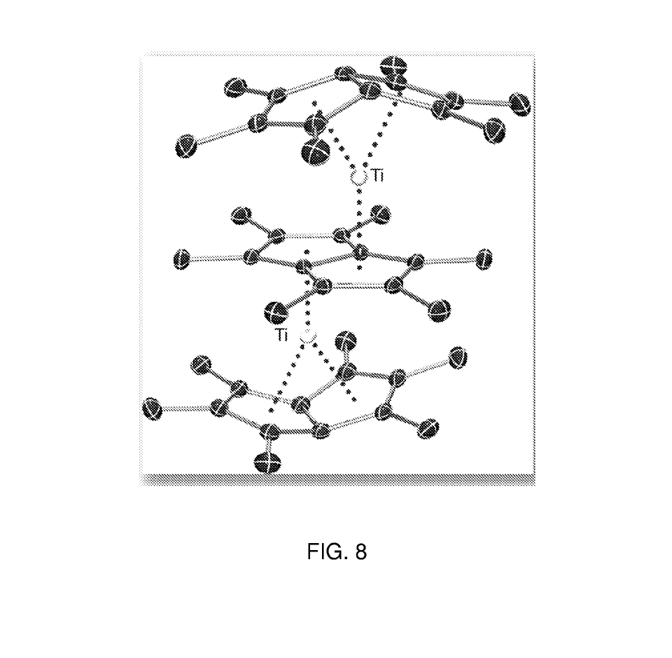

FIG. 8 shows the molecular structure of anti-Pn*(Ti{Pn*})₂, as deduced by X-ray crystallography.

### Example 1—Synthesis and Characterisation of Compounds

### Preparation of anti-Pn*(M{COD})₂ where M=Rh or Ir

Having regard to Scheme 1 shown below, Li₂Pn*(tmeda)_{0.0291} (0.0640 g, 0.312 mmol) and [Rh(COD)Cl]₂ (1 eq.) were combined in thf (1 mL) and the reaction mixture was stirred for 1 h. After removal of the volatiles in vacuo, and subsequent extraction into toluene, recrystallisation afforded anti-Pn*(M{COD})₂.

The molecular structure of anti-Pn*(Rh{COD})₂ deduced by X-ray crystallography is shown in FIG. 1a. The molecular structure of the Ir analogue is shown in FIG. 1b.

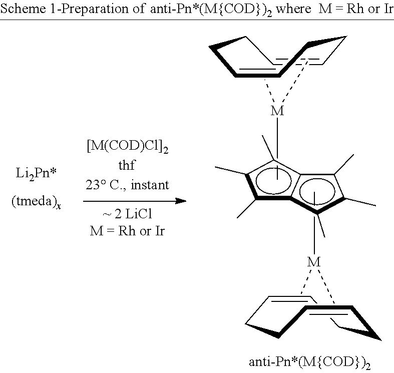

### Preparation of Anti-Pn*(Ni{Cp*})₂

Having regard to Scheme 2 shown below, a red solution of Cp*Niacac (98.4 mg, 0.336 mmol) in 10 mL toluene was added to a slurry of Li₂Pn*TMEDA_{0.102} (35.6 mg, 0.168 mmol) in 10 mL toluene at 25° C. The solution immediately darkened and was stirred for 4 hours, during which the colour turned from red to more orange. The solution was transferred via filter cannula to a new Schlenk, washing the chalky grey residue with more toluene, The filtrate was concentrated and stored in the −78° C. freezer. After 13 days, black crystals of (NiCp*)₂Pn* had precipitated. Yield 41.1 mg, 0.0715 mmol, 43%.

HRMS (ESI) MSS12897 m/z=572.2354 (predicted 572.2463, Mt), 436 (M⁺-Cp*H), 378 (M⁺-NiCp*H), 364 (M⁺-NiCp*HCH₃), 119. Elemental Analysis found (calculated) for C₃₄H₄₈Ni₂ (MW=574.13) (%): C70.89 (71.13), H8.29 (8.43). IR (solvent/KBr, cm⁻¹) 800 (m), 877 (w), 1022 (m), 1094 (m), 1261 (m), 1376 (m), 1444 (m), 1607 (w), 2854 (m), 2906 (m), 2962 (w), 3451 (br). UV-Vis (toluene) λₘₐₓ (nm) (ε): 671 (1116), 495 (9700), 454 (6316), 373 (4232). ¹H NMR (300 MHz, C₆D₆, 298 K) δ (ppm) 2.45 (12H, s), 2.75 (30H, s), 3.04 (6H, s). ¹H NMR (500 MHz, C₇D₈, 223 K) δ (ppm) 1.93 (30H, s), 2.05 (6H, s), 2.16 (12H, s). ¹³C NMR (500 MHz, C₇D₈, 223 K) δ (ppm) 8.75 (Cp*-CH₃), 9.57 (WT-CH₃), 10.57 (NWT-CH₃), 70.27 (Pn*skeleton C), 91.86 (Cp*-C₅), 92.43 (Pn*skeleton C), 101.45 (Pn*bridgehead C).

The molecular structure of anti-Pn*(Ni{Cp*})₂ deduced by X-ray crystallography is shown in FIG. 2.

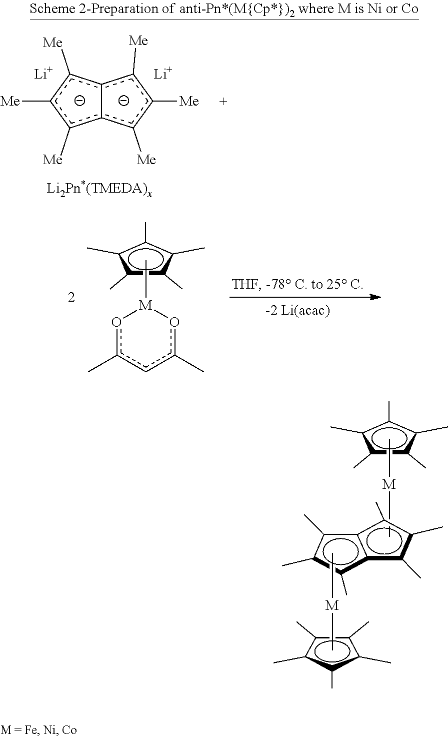

### Preparation of Anti-Pn*(Co{Cp*})₂

Having regard to Scheme 2 shown above, a slurry of Li₂Pn*TMEDA_{0.102} (227 mg, 1.07 mmol, 1 eq.) in 10 mL THF at −78° C. was added quickly to a very dark yellow solution of Cp*Coacac (629 mg, 2.14 mmol, 2 eq.) in 15 mL THF at −78° C., and stirred at this temperature for 1 hour. The mixture was warmed to room temperature, losing its yellow colour and becoming very dark brown-black above −10° C. After stirring for 1 hour at room temperature, the solvent was stripped and the brown-black residue dried at 2×10⁻² mbar for 2 hours. A brown solution was extracted with hexanes (10×20 ml) until washings contained no colour, reduced in volume to 20 mL before transferring via cannula to two mini-Schlenk flasks and storing in a −78° C. freezer. Total yield 187.1 mg, 0.326 mmol, 31%.

HRMS (ESI) MSS12837 m/z=574.2281 (predicted 574.2420, M⁺), 380 (M⁺-CoCp*), 365 (M⁺-CoCpCH₃). IR (solvent/KBr, cm⁻¹) 801 (m), 874 (w), 1025 (m), 1092 (m), 1179 (w), 1261 (m), 1376 (m), 1448 (m), 1548 (w), 1617 (m), 2853 (m), 2899 (m), 2939 (w), 2962 (m), 3442 (br). UV-Vis (toluene) λₘₐₓ (nm) (ε): 596 (2458), 464 (5158), 381 (26024), 289 (6478). ¹H NMR (C₆D₆, 298 K) δ 1.42 (12H, s), 1.48 (30H, s), 2.12 (6H, s). (C₇D₈, 298 K) δ 1.41 (12H, s), 1.45 (30H, s), 2.13 (6H, s). ¹³C{¹H} NMR (300 MHz, C₆D₆, 298 K) δ 9.1 (Cp*-CH₃), 9.8 (NWT-CH₃), 11.8 (WT-CH₃), 59.9 (NWT), 77.1 (bridgehead or WT). 86.1 (Cp*-C₅), 96.4 (bridgehead or WT).

The molecular structure of anti-Pn*(Co{Cp*})₂ deduced by X-ray crystallography is shown in FIG. 3.

### Preparation of Anti-Pn*(Fe{Cp*})₂

A bright green solution Cp*FeCl.TMEDA (441.6 mg, 1.29 mmol) in 10 mL THF was cooled to −78° C. A slurry of Li₂Pn*TMEDA_{0.102} (136.6 mg, 0.64 mmol) in 15 mL THF at −78° C. was added quickly via cannula with vigorous stirring. The dark brown mixture was stirred at −78° C. for 20 minutes then allowed to warm to room temperature, at which it was stirred for a further 1 hour. The THF solvent was removed in vacuo, and after-work-up, black crystals of anti-Pn*(Fe{Cp*})₂ were obtained. Yield 50 mg, 13%.

HRMS (ESI) MSS14379 m/z=568.2523 (predicted 538.2456) [M]⁺, 378 [M+H-FeCp*]⁺, 363 [M+H-FeCp*CH₃]⁺, 348 [M+H-FeCp*(CH₃)₂]⁺, 186 [M-2(FeCp*)]+IR (KBr, cm⁻¹) 668 (m), 801 (m), 851 (m, shoulder), 1026 (m), 1070 (w, shoulder), 1092 (m), 1180 (w), 1261 (m), 1374 (m), 1418 (m, shoulder), 1447 (m), 1471 (m, shoulder), 1568 (m), 2854 (m), 2899 (m), 2939 (m), 2962 (m). UV-Vis (toluene) λₘₐₓ (nm) (ε): 498 (908), 400 (3654), 317 (17594), 288 (14926). ¹H NMR (400 MHz, C₆D₆, 298 K) δ (ppm) 1.46 (6H, s), 1.59 (30H, s), 2.31 (12H, s). ¹³C NMR (400 MHz, C₆D₆, 298 K) δ (ppm) 9.0 (Cp*-CH₃), 10.3 (WT-CH₃), 11.5 (NWT-CH₃), 60.6 (bridgehead), 64.9 (Pn*skeleton-NWT), 78.1 (Cp*-05), 88.9 (Pn*skeleton-WT).

The molecular structure of anti-Pn*(Fe{Cp*})₂ deduced by X-ray crystallography is shown in FIG. 4.

### Preparation of Anti-Pn*(Ni{Cp})₂

Green nickelocene (350 mg, 1.85 mmol, 1.97 eq.) and Li₂Pn*TMEDA_{0.102} were measured into an ampoule containing a stirrer bar, and 30 mL benzene added with stirring, resulting in an immediate dark brown colour. The reaction was sonicated for 1 hour then stirred over the weekend. The dark brown benzene solution was filtered to a new Schlenk, and the grey LiCp residue washed with 3×10 ml benzene until no further colour was extracted. The solvent was removed from the filtrate in vacuo to leave a black residue, yield 114.8 mg, 0.266 mmol, 28.0%.

HRMS (ESI) MSS13014 m/z=432.0900 (predicted 432.0898, M⁺), 366 (M⁺-CpH), 308 (M⁺-NiCpH), 186 (M⁺-2(NiCp)), 123 (NiCp⁺). Elemental Analysis found (calculated) for C₂₄H₂₈Ni₂ (MW=433.87) (%): C66.25 (66.44), H6.60 (6.50). IR (KBr, cm⁻¹) 767 (m, Cp C—H “oop”), 800 (m), 1021 (m), 1094 ( ) 1260.83 (m), 1375 (m), 1443 (m, aromatic C—C stretch), 1618 (w, C═C stretch), 2856 (m, Me C—H stretch), 2903 (m, Me C—H stretch), 2932 (m, Me C—H stretch), 2963 (m, Me C—H stretch), 3098 (w, Cp C—H stretch). UV-Vis (toluene) λₘₐₓ (nm): 602 (720), 478 (3104), 436 (4852), 352 (2248). ¹H NMR (C₆D₆, 298 K) δ (ppm) 2.17 (12H, s), 3.17 (10H, s), 4.17 (6H, s). ¹³C NMR (300 MHz, C₆D₆, 298 K) δ (ppm) 2.92 (WT CH₃), 8.88 (NWT CH₃), 94.99 (Cp), quaternary bridgehead carbons not observed.

FIG. 5 shows the ¹H NMR spectrum of anti-Pn*(Ni{Co})₂.

The molecular structure deduced by X-ray crystallography is shown in FIG. 6.

### Preparation of Anti-Pn*(Co{Cp})₂

A solution of cobaltocene (1026 mg, 5.43 mmol, 1.9 eq) in 10 ml THF was added to a vigorously stirred slurry of Li₂Pn*TMEDA_{0.102} (606 mg, 2.86 mmol, 1 eq.) in 10 ml THF at −78° C. The resulting dark mixture was allowed to warm to room temperature over the course of an hour, then stirred at room temperature overnight. After extensive work-up and crystallisation in benzene at 9° C. for 1 month, black microcrystals of anti-Pn*(Co{Cp})₂ were obtained. Yield 50 mg, 0.114 mmol, 4%.

HRMS (ESI) MSS12976 m/z=434.0858 (predicted 434.0855, M⁺), 309 (M⁺-CoCpH), 295 (M⁺-CoCpCH₃) Elemental Analysis found (calculated) for C₂₄H₂₈Co₂ (MW=434.35) (%): C66.15 (66.37), H6.37 (6.50). IR (solvent/KBr, cm⁻¹) 782 (m, Cp C—H “oop”); 801, 874 (w), 1018, 1104, 1179, 1261, 1374, 1407, 1438 (m, aromatic C—C stretch); 1617 (w, C═C stretch); 2854, 2903, 2941, 2963 (m, Me C—H stretches); 3098 (w, Cp C—H stretch). UV-Vis (toluene) λₘₐₓ (nm) (ε): 600 (2578), 468 (7805), 365 (33781), 285 (12196). ¹H NMR (C₆D₆, 298 K) δ (ppm) 1.55 (12H, s), 2.08 (6H, s), 4.11 (10H, s). ¹³C NMR (300 MHz, C₆D₆, 298 K) δ (ppm) 12.0 (NWT CH₃), 12.3 (WT CH₃), 66.1 (ring WT), 78.0 (Cp), 99.3 (ring NWT), 132.1 (bridgehead).

The molecular structure of anti-Pn*(Co{Cp})₂ deduced by X-ray crystallography is shown in FIG. 7.

While specific embodiments of the invention have been described herein for the purpose of reference and illustration, various modifications will be apparent to a person skilled in the art without departing from the scope of the invention as defined by the appended claims.

1. A compound according to formula (I) shown below: 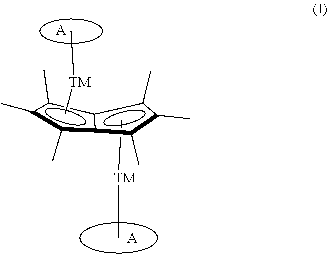
wherein
each TM is independently a transition metal; and
each ring A is independently a 5-8 membered aryl, heteroaryl or partially unsaturated cycloalkyl that is:
i) optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃, and/or
ii) fused to one or more 5- or 6-membered aryl, heteroaryl, or partially unsaturated cycloalkyl rings, either or all of which being optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃,
wherein Rₓ and R_{y} are independently selected from H and (1-4C)alkyl.

2. The compound of claim 1, wherein each TM is independently selected from Rh, Ir, Ti, Ni, Co, Fe and Zr.

3. The compound of claim 1, wherein both TM groups are the same.

4. The compound of any of claim 1, wherein each ring A is independently a 5-8 membered aryl, heteroaryl containing 1, 2 or 3 heteroatoms selected from N, O and S, or partially unsaturated cycloalkyl that is:
1. optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃, and/or
2. fused to one or more 5- or 6-membered aryl, heteroaryl, or partially unsaturated cycloalkyl rings, either or all of which being optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃,
wherein Rₓ and R_{y} are independently selected from H and (1-4C)alkyl.

5. The compound of claim 1, wherein each ring A is independently a 5-8 membered aryl, heteroaryl containing 1 or 2 N heteroatoms, or partially unsaturated cycloalkyl that is:
1. optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃, and/or
2. fused to one or more 5- or 6-membered aryl, heteroaryl, or partially unsaturated cycloalkyl rings, either or all of which being optionally substituted with one or more substituents selected from (1-4C)alkyl, (2-4C)alkenyl, (2-4C)alkynyl; (1-4C)alkoxy, aryl, aryloxy, halo, hydroxyl, nitro, —NRₓR_{y}, —C(O)NRₓR_{y} and —Si[(1-4C)alkyl]₃,
wherein Rₓ and R_{y} are independently selected from H and (1-4C)alkyl.

6. (canceled)

7. The compound of claim 1, wherein each ring A is independently:
1. optionally substituted with one or more substituents selected from (1-3C)alkyl, (2-3C)alkenyl, (2-3C)alkynyl; (1-3C)alkoxy, halo and hydroxyl, and/or
2. fused to one or more 5- or 6-membered aryl, heteroaryl, or partially unsaturated cycloalkyl rings, either or all of which being optionally substituted with one or more substituents selected from (1-3C)alkyl, (2-3C)alkenyl, (2-3C)alkynyl; (1-3C)alkoxy, halo and hydroxyl

8. The compound of claim 1, wherein each ring A is independently:
1. optionally substituted with one or more substituents selected from (1-3C)alkyl, (1-3C)alkoxy, halo and hydroxyl, and/or
2. fused to one or more 5-membered partially unsaturated cycloalkyl ring that is optionally substituted with one or more substituents selected from (1-3C)alkyl, (1-3C)alkoxy, halo and hydroxyl.

9. The compound of claim 1, wherein each ring A is independently selected from: 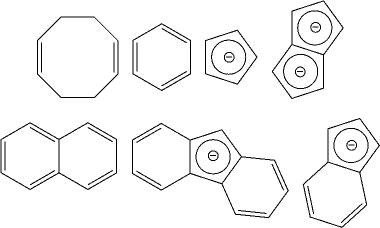
either of which may be optionally substituted with one or more of the ring A substituents recited in any preceding claim.

10. (canceled)

11. The compound of claim 1, wherein each ring A is independently selected from:

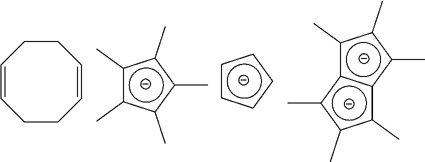

12. The compound of claim 1, wherein both rings A are the same.

13. The compound of claim 1, wherein the compound has a structure according to any of the following:

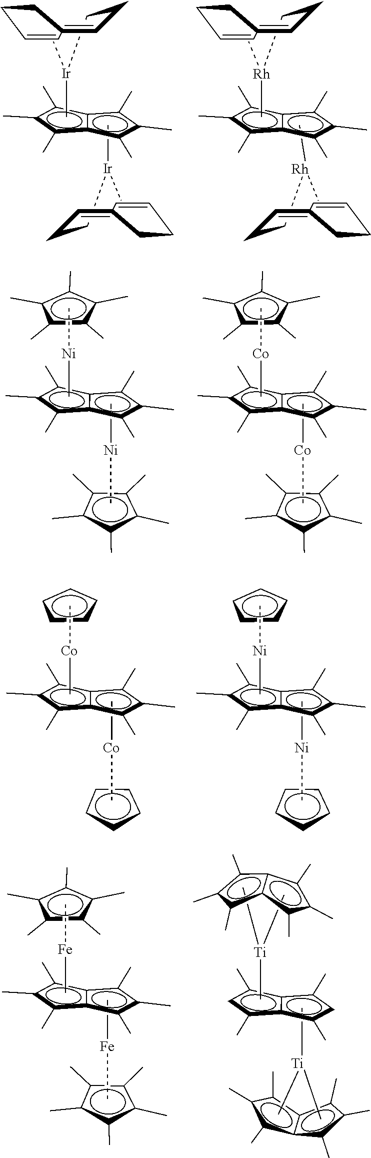

14. A process for the preparation of a compound of formula (I) as claimed in any preceding claim, said process comprising the step of:
1. reacting a compound according to formula (II) shown below with a compound according to formula (III) shown below: 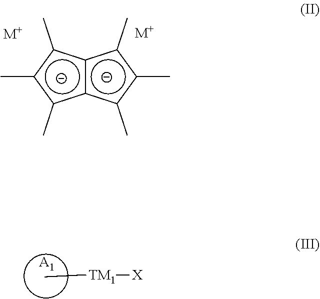
wherein
M is an alkali metal;
ring A₁ has a structure according to ring A as defined in any preceding claim;
TM₁ is as defined for TM in any preceding claim; and
X is a leaving group or a group of formula (IV): 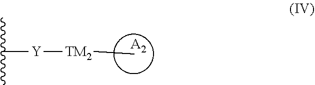
wherein
ring A₂ has a structure according to ring A as defined herein and is the same as or different to A₁;
TM₂ is as defined herein for TM hereinbefore and is the same as or different to TM₁; and
Y is a linking moiety.

15. (canceled)

16. The process of claim 14, wherein the leaving group is selected from (1-10C)alkoxy and aryloxy.

17. The process of any of claim 14, wherein the compound of formula (III) has a structure according to formula (IIIa) or (IIIb) shown below: 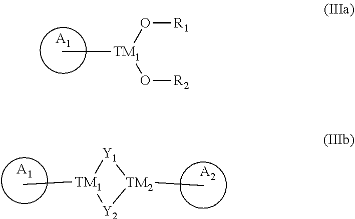
wherein
rings A₁ and A₂ independently have structures according to ring A as defined in any of claims 1 to 13;
TM₁ and TM₂ are independently as defined for TM in any of claims 1 to 13;
R₁ and R₂ are independently (1-8C)alkyl, (2-8C)alkenyl, or R₁ and R₂ are linked such that when taken in combination with the oxygen atoms and TM₁ they collectively form a 6-membered ring that is optionally substituted with one or more substituents selected from (1-3C)alkyl; and
Y₁ and Y₂ are halo.

18. (canceled)

19. A composition comprising a compound of formula (I) according to claim 1 and:
1. a support material; and/or
2. an activator.

20. The composition of claim 19, wherein the support material is selected from silica, MAO-activated silica, layered-double hydroxide (LDH), MAO-activated LDH and solid polymethylaluminoxane.

21. The composition of claim 20, wherein the support material is solid polymethylaluminoxane.

22. The composition of claim 20, wherein the solid polymethylaluminoxane is prepared by heating a solution comprising methylaluminoxane and a hydrocarbon solvent (e.g. toluene).

23. The composition of claim 19, wherein the activator is selected from methylaluminoxane, triisobutylaluminium, diethylaluminium and triethylaluminium.

24. (canceled)

25. A polymerisation process comprising the step of:
1. polymerising ethylene and optionally one or more (3-10C)alkene in the presence of a compound of formula (I) according to claim 1, or a composition thereof.
